(19) United States
(12) Patent Application Publication
(10) Pub. No.: US 2007/0147242 A1
(43) Pub. Date: Jun. 28, 2007

(54) DEVICE FOR OPTIMIZATION OF THE UTILIZATION OF SERVICES IN HYBRID ACCESS NETWORKS

(75) Inventors: Emmanuel Marilly, Saint-Michel-Sur-Orge (FR); Olivier Martinot, Draveil (FR); Mohamed Adel Saidi, Antony (FR); Sylvain Squedin, Nozay (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/613,229

(22) Filed: Dec. 20, 2006

(30) Foreign Application Priority Data
Dec. 26, 2005 (FR) 0554092

(51) Int. Cl. H04L 12/26; H04L 12/56

(52) U.S. Cl. 370/230; 370/395.21

(57) ABSTRACT

An optimization device for an IMS type core network coupled to service applications and to at least two access networks of different types, comprises processing means coupled to the service applications and adapted, when a user terminal connected to one of the access networks requests access to a chosen service, managed by one of the service applications, to optimize the utilization of the requested service as a function of rules defined by that user and/or by an access network operator with which the user has entered into a chosen contract, characteristics of the requested service, and capacities of the terminal and/or characteristics of the contract and/or of each access network enabling access of the terminal to the requested service.

### CROSS-REFERENCE TO RELATED APPLICATIONS

This application is based on French Patent Application No. FR 0554092 filed Dec. 26, 2005, the disclosure of which is hereby incorporated by reference thereto in its entirety, and the priority of which is hereby claimed under 35 U.S.C §119.

### BACKGROUND OF THE INVENTION

1. Field of the Invention

The invention concerns hybrid access networks, and more precisely the utilization of services made available to users by the operators of access networks.

Here “hybrid access networks” means sets of at least two communication networks of different types, also known as “multidomain” networks, enabling user terminals and/or network equipments to set up calls and connected to an IMS (IP Multimedia Subsystem) type core network. It will be a question, for example, of IP connectivity networks (such as GPRS, UMTS, WiFi, WiMax, WLAN or xDSL networks, in particular) and/or traditional networks, such as switched telephone networks of PSTN type (if they are provided with a gateway to an IMS core network).

2. Description of the Prior Art

The number of access networks of different types is continuing to increase. Of these access networks there may in particular be cited fixed networks (for example xDSL or cable networks), mobile or cellular networks (for example GPRS, UMTS or 4G networks), roaming networks (for example WiFi, WiMax networks), broadcast networks (for example DVB-T/H or DMB networks). These access networks generally belonging to different operators, they are therefore generally managed separately taking account of only their own characteristics and capacities, that is to say without distinguishing between the types of contents that come from other access networks and that they are frequently called upon to transport.

For example, if a user having a hybrid or multitechnology (communication) terminal finds himself situated in an area in which he can connect at the same time to a UMTS network and to a WiFi network, he may not or is not able to choose the access technology that is the more suitable, in terms of cost and/or quality of service (QoS) and/or of speed, to a service that he wishes to use, such as a service for retrieving or transmitting mail (e-mail), for example. For their part, the operators of the UMTS and WiFi networks concerned do not always have capacities enabling them to choose the access network or technology that is the best suited to the service requested by a user, for example because of the rate of utilization of their network or because of network constraints linked to a policy.

An object of the invention is therefore to improve on the situation, and more precisely to enable optimization of the utilization of services within hybrid access networks.

### SUMMARY OF THE INVENTION

To this end it proposes an optimization device for an IMS type core network coupled to service applications and to at least two access networks of different types, comprising processing means coupled to the service applications and adapted, when a user terminal connected to one of the access networks requests access to a chosen service, managed by one of the service applications, to optimize the utilization of the requested service as a function of rules defined by that user and/or by the access network operator with which the user has entered into a chosen contract, characteristics of the requested service, and capacities of his terminal and/or characteristics of his contract and/or of each access network enabling access of his terminal to the requested service.

The optimization device according to the invention may have other features and in particular, separately or in combination:
it may comprise first memory means adapted to store the service characteristics;
the service characteristics may be chosen from requirements in terms of deployment, requirements in terms of utilization by a user terminal, at least one access network technology supported, and requirements in terms of quality of service;
it may comprise second memory means adapted to store the characteristics of the access networks;
the access network characteristics may be chosen from accessibility, theoretical performance, available performance, at least one type of service supported, at least one service mode supported, and the costs of utilization of each access technology supported;
it may comprise third memory means adapted to store the capacities of the terminals;
the capacities of the terminals may be chosen from a type and at least one access technology offered;
it may comprise fourth memory means adapted to store the rules defined by the users and each type of contract entered into with (or fixed charge paid to) each access network by each user;
it may comprise fifth memory means adapted to store the rules defined by the access network operators;
its processing means may include an element, chosen in a group comprising at least a rule engine, an expert system and an optimization system, and adapted, in the event of reception of a definition of service requested by a user terminal, to access the memory means to determine each accessible and optimal access network and each access network technology to be used, given requirements in terms of deployment and utilization of the service, rules defined by the operator and/or the user, capacities of the user terminal, and the type of contract entered into by the user.

The invention also proposes a server for an IMS type core network coupled to service applications and to at least two access networks of different types, equipped with an optimization device of the type described hereinabove.

The invention is particularly well adapted, although not exclusively so, to Internet (or IP) connectivity hybrid communication networks. However, generally speaking, it concerns all sets of at least two communication networks of different types, including sets including at least one switched telephone network (for example of PSTN type) provided with a gateway to an IMS core network.

Other features and advantages of the invention will become apparent on examining the following detailed description and the appended drawings.

### BRIEF DESCRIPTION OF THE DRAWINGS

FIG. 1 shows very diagrammatically and functionally one example of a set of two hybrid access networks connected to an IMS type core network to which is coupled an application server equipped with one embodiment of an optimization device according to the invention,

FIG. 2 shows very diagrammatically the principal steps of an exchange of messages between the principal equipments involved in a first example of the utilization of a communication service at the request of a user terminal,

FIG. 3 shows very diagrammatically the principal steps of an exchange of messages between the principal equipments involved in a second example of the utilization of a communication service at the request of a user terminal, and

FIG. 4 shows very diagrammatically the principal steps of an exchange of messages between the principal equipments involved in a third example of the utilization of a communication service at the request of a user terminal.

### DETAILED DESCRIPTION OF PREFERRED EMBODIMENTS

The appended drawings constitute part of the description of the invention as well as contributing to the definition of the invention, if necessary.

An object of the invention is to enable optimization of the utilization of services within a set of at least two hybrid access networks coupled to an IMS type core network.

It is considered by way of nonlimiting example hereinafter that the set of hybrid access networks comprises a fixed access network R1, for example of the high bit rate capacity (xDSL) PSTN switched telephone network type for example, a mobile access network R2, for example of UMTS type, and a roaming access network R3, for example of WiFi type.

However, the invention is not limited to this example of a set of hybrid access networks. In fact it concerns any set of at least two hybrid access networks, of fixed and/or mobile (or cellular) and/or roaming and/or broadcast type, connected to an IMS (IP Multimedia Subsystem) type core network.

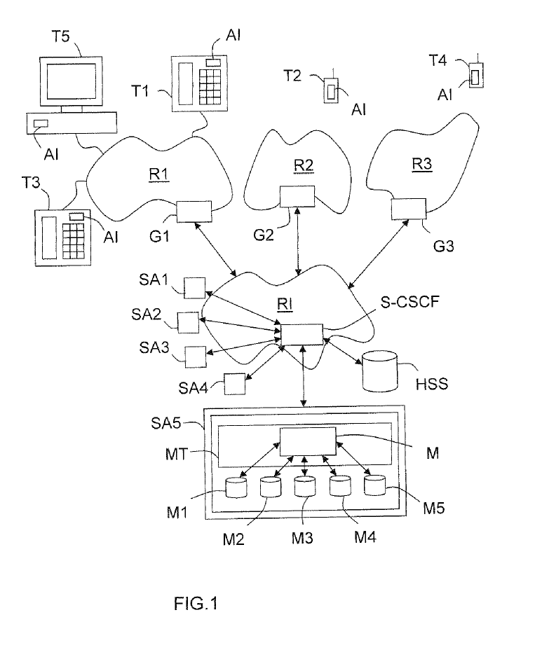

Moreover, in the example shown in FIG. 1, the three access networks Ri (i=1 to 3, R1 to R3) offer IP connectivity, but this is not obligatory.

User terminals Tk provided with an IMS agent AI enabling them to function in an IMS environment are connected (or may be connected) to at least one of the access networks Ri. These terminals Tk may be single-technology terminals (in which case they can be connected to only one type of access network) or multitechnology terminals (in which case they can be connected to several different types of access network).

The same user may have available at least two types of terminal Tk. For example, a user may have a fixed telephone T1 connected to the access network R1 of a first operator with which he has entered into a first contract and a mobile telephone T2 that can be connected to the access network R2 of a second operator, with which he has entered into a first contract, or where applicable another operator that has entered into an agreement with the second operator (when roaming is authorized). A user may equally have entered into a contract with a single operator concerning a plurality of access technologies.

In the example shown, a first user has a fixed telephone T1 with IMS agent AI (where applicable of IP type) connected to the access network R1 and a mobile telephone T2 with IMS agent AI, of UMTS and WiFi types, connectable to the access networks R2 and R3, a second user has a fixed telephone T3 with IMS agent AI (where applicable of IP type), connected to the access network R1, and a mobile telephone T4 with IMS agent AI, of UMTS and WiFi types, connectable to the access networks R2 and R3, and a third user has only an office computer T5 with IMS agent AI connected to an ADSL line of the access network R1.

The components of an IMS network being well known to the person skilled in the art, they will not be described in detail here, as is in particular the case in the specification RFC 23.002 of the 3GPP organization, available on the Internet site of the 3GPP. It is important to note that the mechanisms used by the invention apply equally to core networks based on the core MMD (MultiMedia Domain) technology equivalent to the IMS technology and defined by the 3GPP2 organization.

There are simply summarized hereinafter a few functions of elements or modules of the core network useful for understanding the invention.

An IMS network (or domain) may be connected to a packet-switched network (or domain) R2, such as a UMTS network, for example, and/or to a fixed communication network R1, such as a PSTN network (where applicable ADSL), for example, and/or to a roaming network R3, for example of WiFi or WiMax type, and/or to a Wireless Local Area Network (WLAN).

An IMS network enables subscriber customers (or IMS customers having a communication terminal with IMS agent AI) to have access to specific IMS services managed by application servers, whether they are connected to the access network of the operator with whom they have entered into a contract (or to which they have paid a fixed charge) or to a visited access network in the situation of roaming.

The mode of operation of an IMS network is independent of the access network to which it is connected, and so it may offer services equally well to IP connectivity networks and to networks with no IP connectivity. Consequently, an IMS network enables in particular interworking, taking account of quality of service, roaming, integration and transparency of services, the utilization of a single service interface, and uninterrupted session mobility.

As shown in FIG. 1, each access network Ri (here i=1 to 3) comprises a core network provided with a GGSN (Gateway GPRS Serving Node) module Gi connected to the IMS network RI. Remember that a GGSN module is a node (or router) playing the role of logical interface between its access network Ri and external networks and in particular the IMS network RI core network. It therefore ensures the connectivity of its access network with one or more external networks.

Moreover, the IMS network is also coupled to a subscription database called the HSS (Home Subscriber Server) in which are stored in particular the known addresses of the subscribers to the IMS services that it offers.

The IMS network further comprises an S-CSCF (Serving-Call Session Control Function) module that constitutes the port of entry to the IMS services that it offers. This S-CSCF module is connected to one or more application servers SAj (here j=1 to 5, but may take any value greater than or equal to 2). It is in particular responsible for the authentication of subscribers and is coupled to the HSS in order to recover therefrom information on subscribers and to store therein the known addresses of said subscribers.

Within an IMS (core) network there are usually defined two types of application server SAj. The first type groups together servers including at least one application linked to communications, for example instant or deferred communication applications, “1 to 1” or “1 to many” type communication applications, text data communication applications, voice and video data communication applications, and “push to X” or call or video type communication applications. The second type groups together servers including an application (enabler layer) intended to facilitate a service, such as, for example, applications for detecting the availability and accessibility (or presence) of the user terminals Tk, charging applications, Authentication and Access Control (AAC) applications, applications for determining the positions of the user terminals Tk, applications for monitoring Quality of Service (QoS), and GLMS (Group and List Management Server) type applications.

In FIG. 1, the application servers of the first type are indicated by the squares SA1 and SA2 whereas the application servers of the second type are indicated by the squares SA3 and SA4.

The invention proposes an optimization device D that preferably takes the form of an application intended to form part of an application server (here SA5) connected to the S-CSCF module of the IMS network RI. This application server SA5 is more preferably of the second type (enabler layer).

The optimization device D according to the invention comprises a processing module MT coupled to the other service applications, AS1 to AS4 (first and second types) of its IMS network RI. This processing module MT is responsible for intervening each time that a user terminal Tk connected to one of the access networks Ri connected to its IMS network RI requests access to a chosen IMS service selected managed by one of the service applications AS1 to AS4. More precisely, this processing module MT is responsible for optimizing the utilization of each requested IMS service (managed by one of the application servers AS1 to AS4) as a function, firstly, of rules that are defined by the requesting user and/or by the operator of the access network R1 with which this user has entered into a chosen contract, secondly, the characteristics of the requested service and, thirdly, the capacities of the terminal of this user and/or the characteristics of his contract and/or each network that can enable the terminal to access the requested service.

The processing module MT may be adapted to take account of any type of service characteristic, for example the requirements of each service application AS1 to AS4 in terms of deployment, the requirements of each service application AS1 to AS4 in terms of utilization by a user terminal Tk, each access network technology supported by each service application AS1 to AS4, the requirements in terms of quality of service (QoS), and the SLSs (Service Level Specifications).

The characteristics of the services, which are managed by the service applications of the application servers AS1 to AS4, are stored in first memory means M1. The latter form part of the optimization device D, for example, as in the example shown in FIG. 1. In this case, they are coupled to the processing module MT. However, this is not obligatory. They could in fact be external to the device D and to the application server SA5 that hosts it, provided that they form part of the IMS network RI.

The first memory means M1 may take any form, for example a memory or a database or a directory.

The processing module MT may equally be adapted to take into account any type of characteristic of an access network Ri, for example the accessibility, the theoretical performance and the available performance of each access network Ri connected to its IMS network RI, the cost of utilization of each access technology, each type of service supported by each access network Ri connected to its IMS network RI, and where applicable each service mode supported by each of said types of service.

The characteristics of the access networks Ri are stored in second memory means M2. The latter form part of the optimization device D, for example, as in the example shown in FIG. 1. In this case, they are coupled to the processing module MT. However, this is not obligatory. They could in fact be external to the device D and to the application server SA5 that hosts it provided that they form part of the IMS network RI, or even that they be accessible in the access network.

The second memory means M2 may take any form, for example a memory or a database or a directory.

The processing module MT may equally be adapted to take account of any capacity of the terminal Tk, for example the respective type of the main terminals marketed, or even all of them, and each access technology offered by each type of terminal Tk.

The characteristics of the capacities of the terminals Tk are stored in third memory means M3. The latter form part of the optimization device D, for example, as in the example shown in FIG. 1. In this case, they are coupled to the processing module MT. However, this is not obligatory. It could in fact be external to the device D and to the application server SA5 that hosts it provided that they form part of the IMS network RI, or even that they be accessible in the access network.

The third memory means M3 may take any form, for example a memory or a database or a directory.

The processing module MT may equally be adapted to take account of each type of subscription entered into (or fixed charge paid) by each user vis a vis each access network Ri, as well as any type of rule defined by each user with a view to utilizing one of the services managed by the service applications of the application servers AS1 to AS4.

It will be noted that in the context of IMS services, each operator may make available to its IMS user customers (or IMS subscribers) IMS subscriptions or fixed charges enabling them to access more than one type of access network, for example a fixed network, a mobile network, an xDSL network and a roaming network, all connected to an IMS network RI core network.

Given this hypothesis, each operator may have its own optimization device D installed in its own application server SA5 or in a common application server. It may equally be envisaged that a single optimization device D manages the optimization of the utilization of the IMS services for all the operators.

A user rule may take one of the following forms, for example:
“use a certain quality of service (QoS) for a certain type of call”,
“give priority to using the access network that is the least costly in terms of time-credit”,
“during the month give priority to calling fixed telephones and if there is no response calling mobile telephones”,
“if the total time of calls to mobile telephones exceeds 30 minutes during the last week of the month, then give priority to calling mobile telephones”,
“if the time-credit for calls to mobile telephones is used up (<0) then prohibit non-priority calls to mobile telephones”.

Such rules are generally defined as a function of the type of subscription entered into with (or fixed charge paid to) an operator by the user. Thus examples of the last three rules referred to above may be adapted to the situation in which, for his fixed telephone, a user has entered into a monthly contract with a fixed access network R1 operator whereby each call to a fixed telephone costs 1 [symbol] , a time-credit of two hours per month is assigned to calls to mobile telephones, and each call to a mobile telephone beyond that time-credit costs 2 [symbol] .

The user rules and the types of subscription (or fixed charge) are stored in fourth memory means M4. The latter form part of the optimization device D, for example, as in the example shown in FIG. 1. In this case, they are coupled to the processing module MT. However, this is not obligatory. They could in fact be external to the device D and to the application server SA5 that hosts it provided that they form part of the IMS network RI.

The fourth memory means M4 may take any form, for example a memory or a database or a directory.

The processing module MT may equally be adapted to take account of any type of rule defined by each operator of an access network Ri connected to its IMS network RI with a view to utilizing one of the services managed by the service applications of the application servers AS1 to AS4.

An operator rule may, for example, concern a portion of a policy to be applied to users as a function of their contract type, for example to define preferences for the utilization of access technologies.

The operator rules are stored in fifth memory means M5. The latter form part of the optimization device D, for example, as in the example shown in FIG. 1. In this case, they are coupled to the processing module MT. However, this is not obligatory. It could in fact be external to the device D and to the application server SA5 that hosts it provided that they form part of the IMS network RI.

The fifth memory means M5 may take any form, for example a memory or a database or a directory.

In a first variant, the fourth memory means M4 and the fifth memory means M5 may constitute two portions of the same memory means.

In a second variant, the third memory means M3 and the fourth memory means M4 may constitute two portions of the same memory means.

In a third variant, the second memory means M2 and the fifth memory means M5 may form two portions of the same memory means.

Although this is not shown in FIG. 1, there may be added to the optimization device D a graphical interface, for example of the GUI (Graphical User Interface) type, in order to enable users and/or operators to define their respective rules. This graphical interface may be offered via the Multimedia Resource Function (MRF) that an IMS network generally uses.

The processing module MT may include, for example, an element MR selected from a rule engine, an expert system and an optimization system and responsible, each time that it receives the definition of a service requested by a user terminal Tk, to access the memory means M1 to M5 in order to determine all of the information necessary for the optimization of said service. Of that information, there may be cited in particular the access networks Ri that are accessible to the requesting terminal Tk given its type and/or the access technologies available to it, the data relating to available performance and to the accessibility of the access networks, the access technologies, the performance of the access network and where applicable the quality of service necessary for the requested service, the rules defined by the user of the requesting terminal Tk and relevant to the requested service, each type of contract entered into (or fixed charge paid) by the user of the requesting terminal Tk, and the rules defined by the operator with which the user of the requesting terminal Tk has entered into a contract and that are relevant to the requested service.

Once in possession of all this information, the rule engine (or expert system or optimization system) MR can determine the access network Ri that is accessible and the access network technology whereof can be used that is supported by the requesting terminal Tk and that is the best suited to the utilization of the requested service, given its requirements in terms of deployment and utilization, the contract of the user of the requesting terminal Tk that corresponds to the chosen access technology, and rules that have been defined by the operator and/or the user.

Once the processing module MT has effected its choice of access technology and access network R1, and has determined each rule relevant to the requested service, it has “final” information. It then contacts the application server SAj that hosts the application that manages the service that the requesting terminal Tk wishes to use, in order to communicate to it the final information necessary for optimum utilization of the requested service. It is then this application server SAj that checks the making available of the requested service to the requesting terminal Tk, according to the final information received.

It is important to note that the processing module MT may be adapted to intervene during utilization of a service. In fact this may be useful whenever a user terminal is no longer able to use the access technology that the device D has chosen for it, for example because it has moved and/or the access network Ri used until then no longer has sufficient resources and/or it no longer has sufficient time-credit.

This type of intervention is intended to enable the determination of new final information taking account of the updating of the information stored in at least some of the memory means M1 to M5.

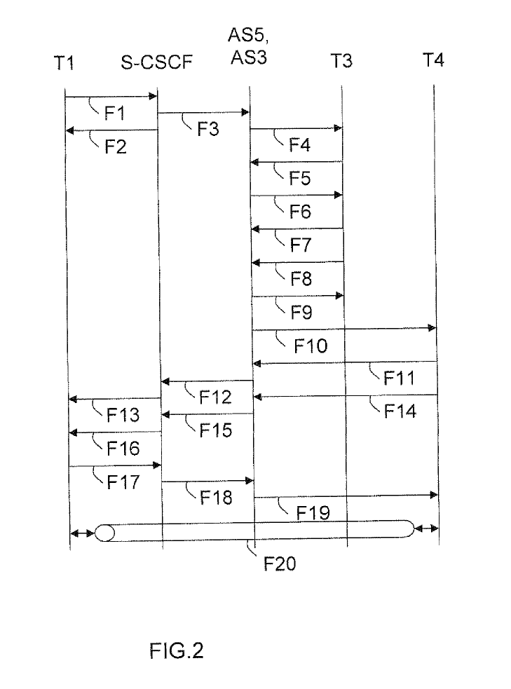

Three examples of the optimized utilization of services are described next with reference to FIGS. 2 to 4. These three service utilization examples correspond to a situation in which a first user (having a fixed telephone T1 and a mobile telephone T2) requests to set up a call between his fixed terminal T1 and a terminal of a second user (having a fixed telephone T3 and a mobile telephone T4). It is further considered that the first user has entered into a monthly contract with the operator of the fixed access network R1 whereby each call to a fixed telephone costs 1 [symbol] , a time-credit of two hours per month is allocated to calls to mobile telephones, and each call to a mobile telephone beyond the time-credit costs 2 [symbol] . It is finally considered that the first user has defined the following set of rules: “during the month give priority to calling fixed telephones and if there is no response calling mobile telephones”, “if the total time of calls to mobile telephones exceeds 30 minutes during the last week of the month, then give priority to calling mobile telephones”, and “if the time-credit for calls to mobile telephones is used up (<0) then prohibit non-priority calls to mobile telephones”.

The first service utilization example, illustrated in FIG. 2, corresponds to the situation where, on the one hand, the first user is in the middle of his contract month and has not used up all of his time-credit for calls to mobile telephones and, on the other hand, the fixed terminal T3 of the second user does not answer.

In a first step F1, the fixed terminal T1 transmits a first message (for example of the “Invite” type) requesting the setting up of a call to the (designated) second user. This message reaches the S-CSCF module of the IMS network RI.

In a second step F2, the S-CSCF module transmits a second message (for example of the “100” or “Trying” type) to the fixed telephone T1 to tell it that it is trying to set up the requested call.

In a third step F3, the S-CSCF module forwards the first message (for example of the “Invite” type) to the application server SA5 that contains the optimization device D according to the invention. The latter proceeds to determine final information relating to the requested service and transmits it to the application server (for example SA3) that hosts the application managing the requested call set-up service. This mode of operation is especially suitable for “back-to-back” type applications such as pre-payment applications. For other types of applications, the optimization device D can transmit the final information directly to the S-CSCF module that monitors the IMS services of a user.

According to the rules defined by the first user, priority must be given to calling the fixed telephone T3 of the second user. Consequently, in a fourth step F4, the application server SA3 forwards the first message (for example of the “Invite” type) to the fixed telephone T3 of the second user. The ringer of the fixed telephone T3 is triggered on reception of this first message.

Then, in a fifth step F5, the fixed telephone T3 sends the application server SA3 (responsible for the call service) a third message (for example of the “180” or “Ringing” type) in order to tell it that ringing is in progress.

The application managing the call service in the application server SA3 then waits for a few moments. Receiving no new message from the fixed telephone T3, it deduces from this that the second user is not answering, and then decides to terminate the attempt to set up a call to the fixed telephone T3 in order to attempt to set up a call to the mobile telephone T4 of the second user, in accordance with the rules defined by the first user (transmitted in the form of final information by the application server SA5). In a sixth step S6, the application server SA3 transmits to the fixed telephone T3 a fourth message (for example of the “Cancel” type) in order to cancel the call set-up procedure previously initiated.

On receipt of this fourth message, the fixed telephone T3 interrupts the ringing, after which, in a seventh step F7, it transmits to the application server SA3 a fifth message (for example of the “200” or “OK” type) in order to tell it that it has interrupted ringing. Then, in an eighth step F8, the fixed telephone T3 transmits to the application server SA3 a sixth message (for example of the “487” or “Request terminated” type) in order to tell it that it has terminated the call set-up attempt. In a ninth step F9, the application server SA3 transmits to the fixed telephone T3 a seventh message (for example of the “ACK” type) in order to acknowledge reception of the sixth message (F8).

Because of the rules defined by the user and previously received, the application server SA3 knows that it must from then on attempt to set up a call between the fixed telephone T1 of the first user and the mobile telephone T4 of the second user. In a tenth step F10, it then transmits to the mobile telephone T4 an eighth message (for example of the “Invite” type) in order to initiate the setting up of a call.

Then, in an eleventh step F11, the mobile telephone T4 sends to the application server SA3 (responsible for the call service) a ninth message (for example of the “180” or “Ringing” type) in order to tell it that ringing is in progress.

When the application server SA3 has received the ninth message, it forwards it to the S-CSCF module in the twelfth step F12. Then, when the S-CSCF module has received the ninth message in its turn, it forwards it to the fixed telephone T1 of the first user in a thirteenth step F13.

If the second user accepts the call on his mobile telephone T4, the latter transmits to the application server SA3, in a fourteenth step F14, a tenth message (for example of the “200” or “OK” type) in order to indicate to it that the call has been accepted.

When the application server SA3 has received the tenth message, it forwards it to the S-CSCF module in a fifteenth step F15. Then, when the S-CSCF module has received the tenth message in its turn, it forwards it to the fixed telephone T1 of the first user in a sixteenth step F16.

In a seventeenth step F17, the fixed telephone T1 transmits to the fixed telephone T3 an eleventh message (for example of the “ACK” type) in order to acknowledge reception of the tenth message (F16). When the S-CSCF module has received the eleventh message, it forwards it to the application server SA3 in an eighteenth step F18. Then, when the application server SA3 has received the eleventh message (F18) in its turn, it forwards it to the mobile telephone T4 in a nineteenth step F19. The call between the fixed telephone T1 and the mobile telephone T4 may then take place a in twentieth step F20 by means of the RTP protocol, for example in media stream form.

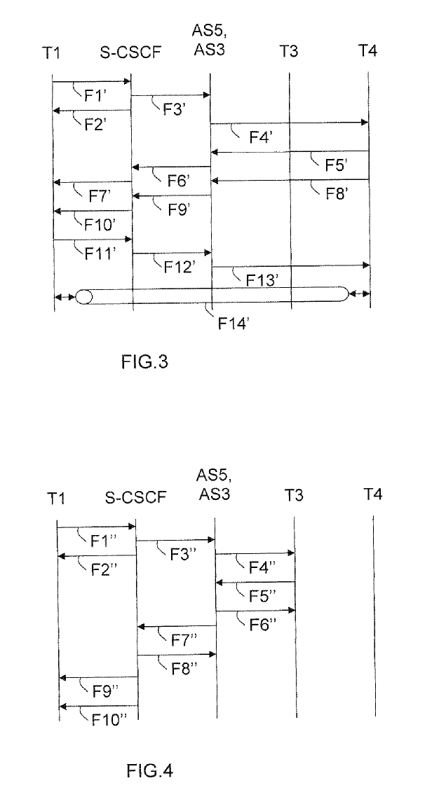

The second service utilization example, illustrated in FIG. 3, corresponds to the situation in which the first user finds himself in the last week of his contract month and still has a time-credit for calls to mobile telephones equal to 50 minutes.

In a first step F1′, the fixed terminal T1 transmits a first message (for example of the “Invite” type) requesting the setting up of a call to the (designated) second user. This message reaches the S-CSCF module of the IMS network RI.

In a second step F2′, the S-CSCF module transmits a second message (for example of the “100” or “Trying” type) to the fixed telephone T1 in order to tell it that it is attempting to set up the requested call.

In a third step F3′, the S-CSCF module forwards the first message (for example of the “Invite” type) to the application server SA5 that contains the optimization device D according to the invention. The latter proceeds to the determination of the final information relating to the requested service and transmits it to the application server (for example SA3) that hosts the application managing the requested call set-up service.

This mode of operation is especially suitable for “back-to-back” applications, such as pre-payment applications. For other types of applications, the optimization device D may transmit the final information directly to the S-CSCF module that monitors the IMS services of a user.

According to the rules defined by the first user, priority must be given to calling the mobile telephone T4 of the second user because this is the last week of the contract month and the call-time credit for calls to mobile telephones exceeds 30 minutes. Consequently, in a fourth step F4′, the application server SA3 forwards to the mobile telephone T4 the first message (for example of the “Invite” type) in order to initiate the setting up of a call.

Then, in a fifth step F5′, the mobile telephone T4 sends to the application server SA3 (responsible for the call service) a third message (for example of the “180” or “Ringing” type) in order to tell it that ringing is in progress.

When the application server SA3 has received the third message, it forwards it to the S-CSCF module in a sixth step F6′. Then, when the S-CSCF module has received the third message in its turn, it forwards it to the fixed telephone T1 of the first user in a seventh step F7′.

If the second user accepts the call on his mobile telephone T4, the latter transmits to the application server SA3, in an eighth step F8′, a fourth message (for example of the “200” or “OK” type) in order to tell it that the call has been accepted.

When the application server SA3 has received the fourth message, it forwards it to the S-CSCF module in a ninth step F9′. Then, when the S-CSCF module has received the fourth message in its turn, it forwards it to the fixed telephone T1 of the first user in a tenth step F10′.

In an eleventh step F11′, the fixed telephone T1 transmits to the fixed telephone T3 a fifth message (for example of the “ACK” type) in order to acknowledge reception of the fourth message (F10′). When the S-CSCF module has received the fifth message, it forwards it to the application server SA3 in a twelfth step F12′. Then, when the application server SA3 has received the fifth message (S12′) in its turn, it forwards it to the mobile telephone T4 in a thirteenth step F13′. The call between the fixed telephone T1 and the mobile telephone T4 may then take place in a fourteenth step F14′ by means of the RTP protocol, for example in media stream form.

The third service utilization example, illustrated in FIG. 4, corresponds to the situation in which, on the one hand, the first user has used up his time-credit for calls to mobile telephones and, on the other hand, the call is not an urgent (or priority) call.

In a first step F1″, the fixed terminal T1 transmits a first message (for example of the “Invite” type) requesting the setting up of a call to the (designated) second user. This message reaches the S-CSCF module of the IMS network RI.

In a second step F2″, the S-CSCF module transmits a second message (for example of the “100” or “Trying” type) to the fixed telephone T1 in order to tell it that it is trying to set up the requested call.

In a third step F3″, the S-CSCF module forwards the first message (for example of the “Invite” type) to the application server SA5 that contains the optimization device D according to the invention. The latter proceeds to the determination of the final information relating to the requested service and transmits it to the application server (for example SA3) that hosts the application managing the requested call set-up service.

This mode of operation is particularly suitable to “back-to-back” applications, such as pre-payment applications. For other types of application, the optimization device D may transmit the final information directly to the S-CSCF module that controls the IMS services of a user.

According to the rules defined by the first user, only the fixed telephone T3 of the second user must be called. Consequently, in a fourth step F4″, the application server SA3 forwards the first message (for example of the “Invite” type) to the fixed telephone T3 of the second user.

Here it is considered that the second user is temporarily unavailable. Consequently, when the fixed telephone T3 receives the first message, it sends to the application server SA3 (responsible for the call service), in a fifth step F5″, a third message (for example of the “480” or “Temporarily unavailable” type) in order to tell it that its (second) user is unavailable.

In a sixth step F6″, the application server SA3 transmits to the fixed telephone T3 a fourth message (for example of the “ACK” type) in order to acknowledge reception of the third message (F5″).

According to the rules defined by the first user, the mobile telephone T4 of the second user may not be called. Consequently, in a seventh step F7″, the application server SA3 forwards to the S-CSCF module the third message (for example of the “480” or “Temporarily unavailable” type). On reception of this third message, the S-CSCF module sends to the application server SA3, in an eighth step F8″, an eighth message (for example of the “ACK” type) in order to acknowledge reception of the third message (F7″).

Then, in a ninth step F9″, the S-CSCF module forwards to the fixed telephone T1 of the first user the third message (for example of the “480” or “Temporarily unavailable”) type. On reception of this third message, the fixed telephone T1 sends to the S-CSCF module, in a tenth step F10″, a sixth message (for example of the “ACK” type) in order to acknowledge reception of the third message (F9″). The procedure is interrupted at this stage without it having been possible to set up a call.

The optimization device D according to the invention, and in particular its processing module MT and where applicable its memory means M1 to M5, may take the form of electronic circuits, software (or electronic data processing) modules, or a combination of circuits and software.

The invention offers several advantages, including:
improved management for users of their contracts (or fixed charges) and the access technologies offered by their communication terminals,
the possibility of managing and optimizing the resources of the access network operators,
reduced costs for the access network operators and for their user customers, because of the sharing of tasks between access networks.

The invention is not limited to the optimization device and application server embodiments described hereinabove by way of example only, and encompasses all variants that the person skilled in the art might envisage that fall within the scope of the following claims.

1. An optimization device for an IMS type core network coupled to service applications and to at least two access networks of different types, comprising processing means coupled to said service applications and adapted, when a user terminal connected to one of said access networks requests access to a chosen service, managed by one of said service applications, to optimize the utilization of said requested service as a function of rules defined by that user and/or by an access network operator with which said user has entered into a chosen contract, characteristics of said requested service, and capacities of said terminal and/or characteristics of said contract and/or of each access network enabling access of said terminal to said requested service.

2. A device according to claim 1, comprising first memory means adapted to store said service characteristics.

3. A device according to claim 1, wherein said service characteristics are chosen in a group comprising at least requirements to be deployed, requirements to enable utilization by a user terminal, requirements in terms of quality of service, and at least one access network technology supported.

4. A device according to claim 1, comprising second memory means adapted to store said characteristics of the access networks.

5. A device according to claim 1, wherein said access network characteristics are chosen in a group comprising at least accessibility, theoretical performance, available performance, at least one type of service supported, at least one service mode supported, and costs of utilization of each access technology supported.

6. A device according to claim 1, comprising third memory means adapted to store said capacities of the terminals.

7. A device according to claim 1, wherein said capacities of the terminals are chosen in a group comprising at least one type and at least one access technology offered.

8. A device according to claim 1, comprising fourth memory means adapted to store said rules defined by the users and/or each type of contract entered into by each user with each access network.

9. A device according to claim 1, comprising fifth memory means adapted to store said rules defined by the access network operators.

10. A device according to claim 1, wherein said processing means include an element, chosen in a group comprising at least a rule engine, an expert system and an optimization system, and adapted, in the event of reception of a definition of service requested by a user terminal, to access said memory means to determine each accessible and optimal access network and each access network technology to be used, given requirements in terms of deployment and utilization of said service, rules defined by the operator and/or the user, capacities of said user terminal, and each contract entered into by said user.

11. An application server for an IMS type core network coupled to service applications and to at least two access networks of different types, comprising an optimization device according to claim 1.
